(19) United States
(12) Patent Application Publication
(10) Pub. No.: US 2026/0145129 A1
(43) Pub. Date: May 28, 2026

(54) CARBON DIOXIDE CAPTURE AGENT AND CARBON DIOXIDE CAPTURE AND REDUCTION SYSTEM USING THE SAME

(71) Applicant: KOREA INSTITUTE OF SCIENCE AND TECHNOLOGY, Seoul (KR)

(72) Inventors: Dahye WON, Seoul (KR); Hyun Joo LEE, Seoul (KR); Ung LEE, Seoul (KR); Kyeongsu KIM, Seoul (KR); Jiyun KIM, Seoul (KR); KEZIA MEGAGITA GERBY LANGIE, Seoul (KR); Wonsuk CHUNG, Seoul (KR); Daehyun LIM, Seoul (KR)

(21) Appl. No.: 19/254,289

(22) Filed: Jun. 30, 2025

(30) Foreign Application Priority Data
Nov. 28, 2024 (KR) 10-2024-0174134

(51) Int. Cl. B01D 53/62; B01D 53/32; B01D 53/96

(52) U.S. Cl. CPC B01D 53/62; B01D 53/326; B01D 53/965; B01D 2251/206; B01D 2257/504

(57) ABSTRACT

The present disclosure discloses a carbon dioxide capture agent and a carbon dioxide capture and reduction system using the same. The system includes an electrochemical reaction unit including a reduction electrode, an oxidation electrode, and a separation membrane separating the reduction electrode and the oxidation electrode; a carbon dioxide capture unit capturing carbon dioxide and supplying a carbon dioxide capture solution to the reduction electrode of the electrochemical reaction unit; and an oxidation reaction electrolyte unit supplying an aqueous solution to the oxidation electrode of the electrochemical reaction unit, and the carbon dioxide capture unit includes the carbon dioxide capture agent. The carbon dioxide capture agent can be regenerated through a subsequent electrochemical reaction after capturing carbon dioxide.

### CROSS REFERENCE TO RELATED APPLICATION

The present application claims priority to Korean Patent Application No. 10-2024-0174134, filed Nov. 28, 2024, the entire contents of which are hereby incorporated by this reference.

### BACKGROUND OF THE INVENTION

### Field of the Invention

The present disclosure discloses a carbon dioxide capture agent and a carbon dioxide capture and reduction system using the same.

### DESCRIPTION OF GOVERNMENT-SPONSORED RESEARCH & DEVELOPMENT

This research was conducted at the Korea Institute of Science and Technology under the management of the National Research Foundation of Korea, which is under the Ministry of Science and ICT, the research business title is Korea Institute of Science and Technology Research Operating Expenses Support (Major Project Expenses), and the research project title is Development of e-chemical manufacturing technology (Project Specific No.: 2710034021, Project No.: 2E33250).

Further, this research was conducted at the Korea Institute of Science and Technology under the management of the National Research Foundation of Korea, which is under the Ministry of Science and ICT, the research business title is DACU Source Technology Development (R&D), and the research project title is Development of Source Technology for Simultaneous Capture and Conversion of Carbon Dioxide in the Air (Project Specific No.: 2710002791, Project No.: 00259920).

### Description of the Related Art

The greenhouse effect caused by carbon dioxide released by the use of fossil fuels such as coal and natural gas not only leads to global warming and climate change, but also brings about global environmental problems that have significant environmental, social, and economic impacts.

As the environmental problems caused by carbon dioxide emissions are becoming increasingly serious as described above, methods for solving such problems have been sought. As a method for reducing carbon dioxide, research has been conducted on the technology of converting carbon dioxide into useful fuel materials, but the technology is still not being put to good use.

### SUMMARY OF THE INVENTION

In one aspect, an object of the present disclosure is to provide a carbon dioxide capture agent.

In another aspect, an object of the present disclosure is to provide a carbon dioxide capture and reduction system using the carbon dioxide capture agent.

In one aspect, the present disclosure provides a carbon dioxide capture agent having a structure of the following Chemical Formula 1.

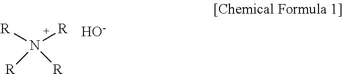

In the formula, R is an alkyl having 1 to 6 carbon atoms.

In an exemplary embodiment, the capture agent may have any one of the structures of Chemical Formulae 2 to 5.

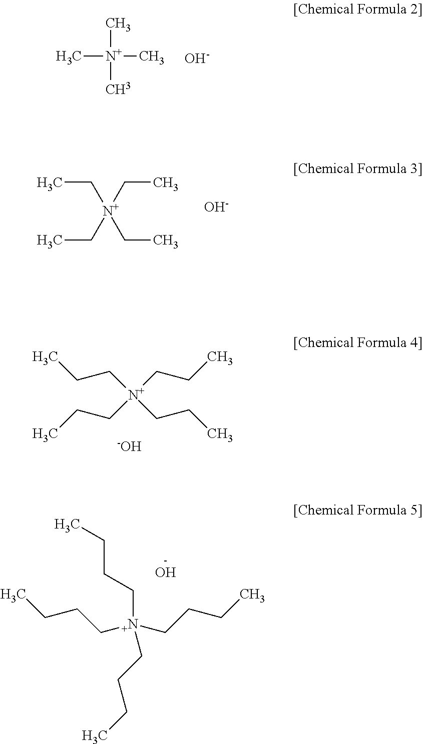

In an exemplary embodiment, the carbon dioxide capture agent may be used at a concentration of 20 wt % or more based on the total weight of a capture agent solution.

In an exemplary embodiment, the capture agent may be capable of capturing carbon dioxide at a concentration of 10 ppm to 5,000 ppm.

In an exemplary embodiment, the capture agent may be reusable after an electrochemical reaction of the captured carbon dioxide.

In another aspect, the present disclosure provides a carbon dioxide capture and reduction system using the carbon dioxide capture agent, wherein the system includes: an electrochemical reaction unit including a reduction electrode, an oxidation electrode, and a separation membrane separating the reduction electrode and the oxidation electrode; a carbon dioxide capture unit supplying a carbon dioxide capture solution to the reduction electrode of the electrochemical reaction unit; and an oxidation reaction electrolyte unit supplying an aqueous solution to the oxidation electrode of the electrochemical reaction unit, and the carbon dioxide capture unit includes the carbon dioxide capture agent.

In an exemplary embodiment, the carbon dioxide capture unit may include: a first supply line through which the carbon dioxide capture solution is supplied to the reduction electrode of the electrochemical reaction unit; a first inlet line through which the reduction electrode reactant is introduced; and a first outlet line through which a syngas in the reduction electrode reactant is discharged.

In an exemplary embodiment, the system may supply the carbon dioxide capture solution to the reduction electrode of the electrochemical reaction unit, reduce captured carbon dioxide through an electrochemical reaction, and introduce a reduction reactant into the carbon dioxide capture unit.

In an exemplary embodiment, the system may further include capturing carbon dioxide in the carbon dioxide capture unit.

In an exemplary embodiment, the system may further include reusing a carbon dioxide capture agent contained in the reduction reactant introduced into the carbon dioxide capture unit, to supply a carbon dioxide capture solution comprising captured carbon dioxide to the reduction electrode of the electrochemical reaction unit.

In an exemplary embodiment, the reduction reactant may include a compound produced through the electrochemical reaction and a carbon dioxide capture agent in an initial capture agent state.

In an exemplary embodiment, the reduction electrode may include one or more metals selected from the group consisting of silver, gold, zinc, nickel, cobalt, iron, and manganese, and the reduction reactant may include carbon monoxide.

In an exemplary embodiment, the reduction electrode may include one or more metals selected from the group consisting of tin, copper, bismuth, palladium, and indium, and the reduction reactant may include formate.

In an exemplary embodiment, the reduction electrode may include copper metal, and the reduction reactant may include one or more selected from the group consisting of ethylene, ethanol, acetate, propanol, and methanol.

In one aspect, the technology disclosed in the present disclosure has an effect of providing a carbon dioxide capture agent.

The capture agent is capable of capturing carbon dioxide from the air and is applicable to an electrochemical conversion system. In addition, the capture agent can be regenerated through an electrochemical reaction.

In another aspect, the technology disclosed in the present disclosure has an effect of providing a carbon dioxide capture and reduction system using the carbon dioxide capture agent.

The system is capable of efficiently producing useful compounds through an electrochemical reaction from carbon dioxide concentrated in the capture agent.

### BRIEF DESCRIPTION OF THE DRAWINGS

FIG. 1 illustrates a schematic view of a carbon dioxide capture and reduction system according to an example.

FIG. 2 illustrates a reaction schematic view in which carbon monoxide is produced in an electrochemical reaction unit according to an example.

FIG. 3 illustrates a reaction schematic view in which formic acid is produced in an electrochemical reaction unit according to an example.

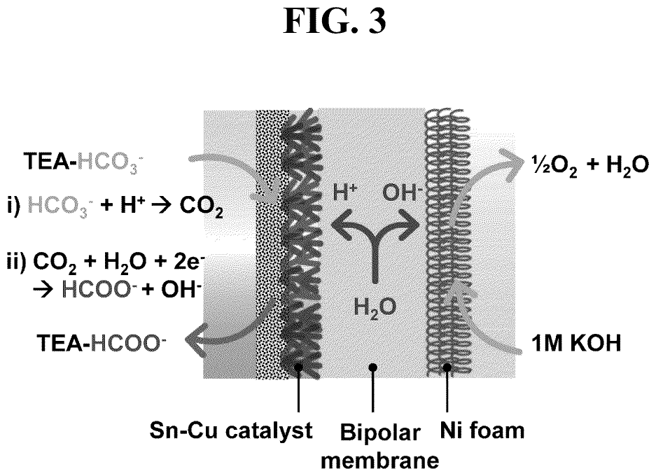

FIG. 4 illustrates a schematic view of a reduction electrode according to an example.

FIG. 5 illustrates a reaction result of producing carbon monoxide through a carbon dioxide capture and reduction system according to an example.

FIG. 6 illustrates the change in the amount of carbon monoxide produced during a long-term reaction of 80 hours in a carbon dioxide capture and reduction system according to an example.

FIG. 7 illustrates the changes in formate, bicarbonate, and OH concentrations during a long-term reaction of 80 hours in a carbon dioxide capture and reduction system according to an example.

FIG. 8 illustrates the results of confirming the recapture performance of the carbon dioxide capture agent regenerated during a long-term reaction of 80 hours through a carbon dioxide capture and reduction system according to an example.

### DETAILED DESCRIPTION OF THE INVENTION

Hereinafter, the present disclosure will be described in detail.

In one aspect, the present disclosure provides a carbon dioxide capture agent having a structure of the following Chemical Formula 1.

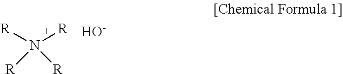

In the formula, R is an alkyl having 1 to 6 carbon atoms.

In an exemplary embodiment, the capture agent may have any one of the structures of Chemical Formulae 2 to 5.

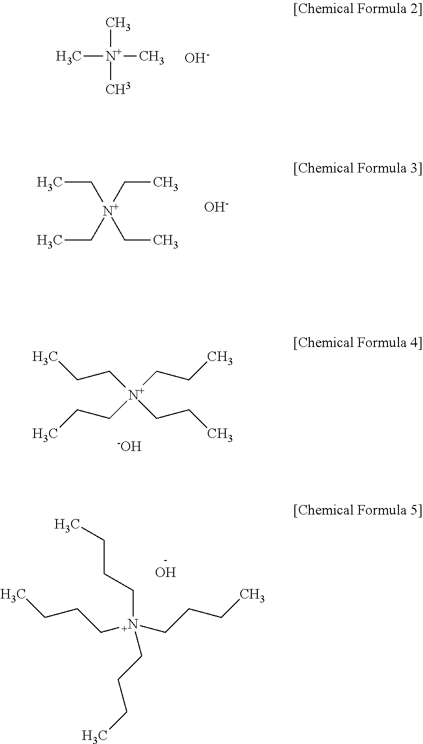

In an exemplary embodiment, the carbon dioxide capture agent may be used at a concentration of 20 wt % or more, 20 wt % to 40 wt %, or 25 wt % to 35 wt %, based on the total weight of the capture agent solution.

In an exemplary embodiment, the capture agent may have a pH of 15.11 to 15.53 before capturing carbon dioxide, and a pH of 8.35 to 8.55 after capturing carbon dioxide. The capture agent exhibits strong basic properties before capturing carbon dioxide, but its pH may decrease to a weakly basic or neutral level after capturing carbon dioxide.

In an exemplary embodiment, the capture agent may provide excellent performance in capturing carbon dioxide at a low concentration of 10 ppm to 5000 ppm, unlike other existing capture agents, as well as in capturing carbon dioxide at a high concentration. In other exemplary embodiments, the capture agent may be capable of capturing carbon dioxide at a concentration of 10 ppm or more, 50 ppm or more, 100 ppm or more, 150 ppm or more, 200 ppm or more, 250 ppm or more, 300 ppm or more, 350 ppm or more, 400 ppm or more, 450 ppm or more, or 500 ppm or more, and 5,000 ppm or less, 4,500 ppm or less, 4,000 ppm or less, 3,500 ppm or less, 3,000 ppm or less, 2,500 ppm or less, 2,000 ppm or less, 1,500 ppm or less, 1,000 ppm or less, 950 ppm or less, 900 ppm or less, 850 ppm or less, 800 ppm or less, 750 ppm or less, 700 ppm or less, 650 ppm or less, 600 ppm or less, 550 ppm or less, or 500 ppm or less.

In an exemplary embodiment, the capture agent may capture carbon dioxide in the air.

In an exemplary embodiment, the capture agent may be reusable after an electrochemical reaction of the captured carbon dioxide. The capture agent has an advantage in that it is capable of capturing carbon dioxide and is applicable to an electrochemical reaction system, and can be regenerated by an electrochemical reaction. In other words, ammonium hydroxide among carbon dioxide capture agents cannot be regenerated due to salt formation, whereas the present disclosure has an effect of enabling an capture agent to be regenerated through a subsequent electrochemical reaction after capturing carbon dioxide using tetraalkylammonium hydroxide (TEA) having a structure of Chemical Formula 1 as a carbon dioxide capture agent. Meanwhile, carbon dioxide capture agents containing potassium in the related art also have a problem due to salt formation, and triethylamine has a problem in that it is difficult to capture carbon dioxide in the air. Although triethylamine can be regenerated, layer separation occurs due to its property of not being mixed with water.

In another aspect, the present disclosure provides a carbon dioxide capture and reduction system using the carbon dioxide capture agent, wherein the system includes: an electrochemical reaction unit including a reduction electrode, an oxidation electrode, and a separation membrane separating the reduction electrode and the oxidation electrode; a carbon dioxide capture unit supplying a carbon dioxide capture solution to the reduction electrode of the electrochemical reaction unit; and an oxidation reaction electrolyte unit supplying an aqueous solution to the oxidation electrode of the electrochemical reaction unit, and the carbon dioxide capture unit includes the carbon dioxide capture agent.

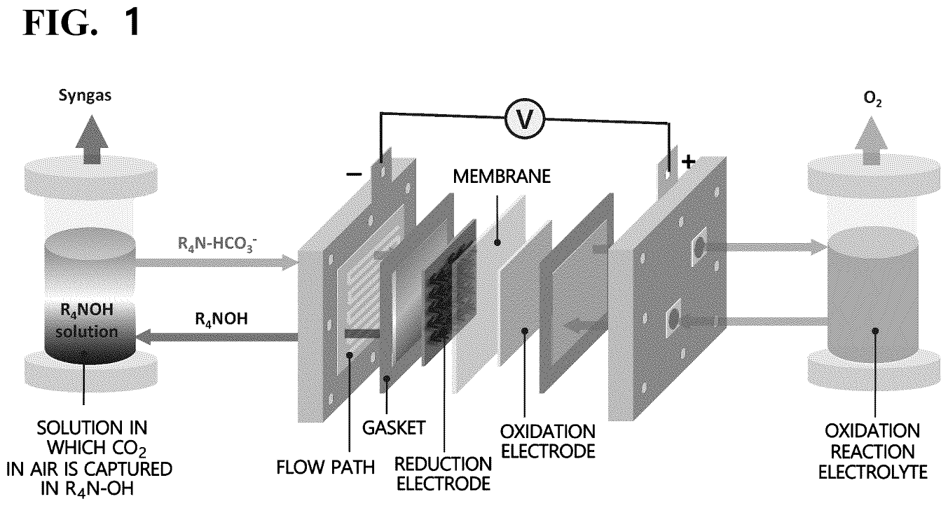

FIG. 1 illustrates a schematic view of a carbon dioxide capture and reduction system according to an example.

In an exemplary embodiment, the electrochemical reaction unit may have a membrane electrode assembly structure.

In an exemplary embodiment, the electrochemical reaction unit may include the reduction electrode; an oxidation electrode facing the reduction electrode; and a separation membrane located between the reduction electrode and the oxidation electrode.

In an exemplary embodiment, the reduction electrode may include a metal catalyst or a metal-carbon catalyst, and the metal may include at least one selected from the group consisting of silver, gold, copper, tin, nickel, zinc, palladium, indium, bismuth, cobalt, iron, and manganese.

In an exemplary embodiment, the oxidation electrode may include a metal catalyst or a metal-carbon catalyst, and the metal may include one or more selected from the group consisting of iridium, rhodium, platinum, nickel, iron, and cobalt.

In an exemplary embodiment, the separation membrane may be a bipolar separation membrane, a cation exchange separation membrane, or an anion exchange separation membrane.

In an exemplary embodiment, the carbon dioxide capture unit may capture carbon dioxide.

In an exemplary embodiment, the carbon dioxide capture unit may include: a first supply line through which the carbon dioxide capture solution is supplied to the reduction electrode of the electrochemical reaction unit; a first inlet line through which the reduction electrode reactant is introduced; and a first outlet line through which a syngas in the reduction electrode reactant is discharged.

In an exemplary embodiment, the carbon dioxide capture unit may include a carbon dioxide inlet through which carbon dioxide is injected, and a carbon dioxide capture agent inlet through which a carbon dioxide capture agent is injected.

In an exemplary embodiment, the carbon dioxide capture unit may be configured by injecting carbon dioxide into the capture unit to capture carbon dioxide, or by injecting a capture solution in which carbon dioxide has been captured.

In an exemplary embodiment, the carbon dioxide may be injected at a concentration of 10 ppm to 5000 ppm. In another exemplary embodiment, the carbon dioxide may be injected at a concentration of 10 ppm or more, 50 ppm or more, 100 ppm or more, 150 ppm or more, 200 ppm or more, 250 ppm or more, 300 ppm or more, 350 ppm or more, 400 ppm or more, 450 ppm or more, or 500 ppm or more, and 5,000 ppm or less, 4,500 ppm or less, 4,000 ppm or less, 3,500 ppm or less, 3,000 ppm or less, 2,500 ppm or less, 2,000 ppm or less, 1,500 ppm or less, 1,000 ppm or less, 950 ppm or less, 900 ppm or less, 850 ppm or less, 800 ppm or less, 750 ppm or less, 700 ppm or less, 650 ppm or less, 600 ppm or less, 550 ppm or less, or 500 ppm or less.

In an exemplary embodiment, for the carbon dioxide, carbon dioxide in the air may be injected.

In an exemplary embodiment, the carbon dioxide capture solution may be a solution in which carbon dioxide is captured by a carbon dioxide capture agent. The reactions in the carbon dioxide capture solution are as follows.

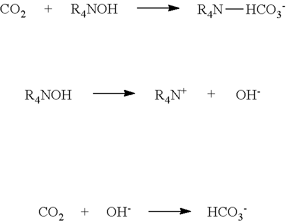

In an exemplary embodiment, the oxidation reaction electrolyte unit may include a second supply line through which the aqueous solution is supplied to an oxidation electrode of an electrochemical reaction unit; a second inlet line through which the oxidation electrode reactant is introduced; and a second outlet line through which oxygen in the oxidation electrode reactant is discharged.

In an exemplary embodiment, the oxidation reaction electrolyte unit may include an aqueous solution inlet through which an aqueous solution is injected.

The carbon dioxide capture and conversion system according to the present disclosure has an effect of converting concentrated carbon dioxide in a carbon dioxide capture solution through an electrochemical system to produce useful compounds.

In an exemplary embodiment, the system may supply the carbon dioxide capture solution to the reduction electrode of the electrochemical reaction unit, reduce captured carbon dioxide through an electrochemical reaction, and introduce a reduction reactant into the carbon dioxide capture unit.

In an exemplary embodiment, the system may further include capturing carbon dioxide in the carbon dioxide capture unit.

In an exemplary embodiment, the system may further include reusing a carbon dioxide capture agent contained in the reduction reactant introduced into the carbon dioxide capture unit, to supply a carbon dioxide capture solution comprising captured carbon dioxide to the reduction electrode of the electrochemical reaction unit. For example, CO₂ captured in the bicarbonate state before the reaction may be converted into formate or carbon monoxide by an electrochemical reaction, and a R₄NOH capture agent may be regenerated.

In an exemplary embodiment, the reduction reactant may include a compound produced through the electrochemical reaction and a carbon dioxide capture agent in an initial capture agent state.

In an exemplary embodiment, the reduction reactant may include a syngas.

In an exemplary embodiment, the syngas may include carbon monoxide.

In an exemplary embodiment, the carbon monoxide may be discharged to the first outlet line.

In an exemplary embodiment, the reduction reactant may include carbon monoxide, formic acid, ethylene, ethanol, acetate, propanol, methanol, or a mixture thereof.

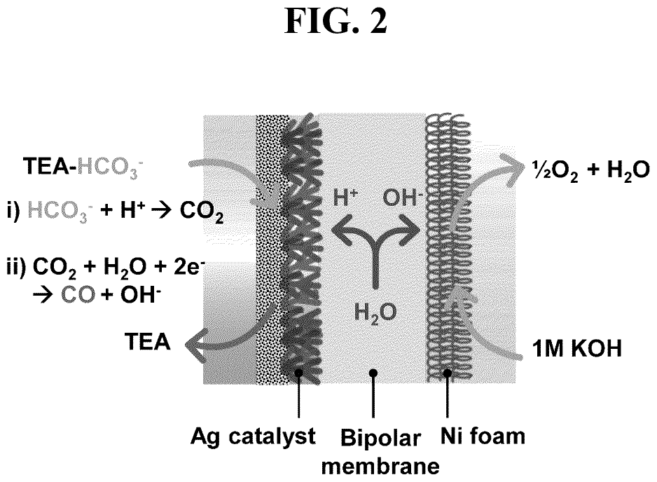

In an exemplary embodiment, when the carbon dioxide capture solution is supplied to a reduction electrode of an electrochemical reaction unit to drive an electrochemical reaction, the bicarbonate in the solution reacts to separate carbon dioxide from the carbon dioxide capture agent. For example, bicarbonate may react with hydrogen ions supplied from the separation membrane to be primarily converted to carbon dioxide, and the converted carbon dioxide may react with water and electrons to be converted into carbon monoxide (see FIG. 2).

In an exemplary embodiment, the reduction reactant may include a carbon dioxide capture agent from which carbon dioxide is separated. Accordingly, the carbon dioxide capture agent can be reused.

The carbon dioxide capture and reduction system according to the present disclosure may be used by adjusting a reduction electrode catalyst according to a desired product.

In an exemplary embodiment, the reduction electrode may include one or more metals selected from the group consisting of silver, gold, zinc, nickel, cobalt, iron, and manganese, and the reduction reactant may include carbon monoxide.

In an exemplary embodiment, the reduction electrode may include one or more metals selected from the group consisting of tin, copper, bismuth, palladium, and indium, and the reduction reactant may include formate.

In an exemplary embodiment, the reduction electrode may include copper metal, and the reduction reactant may include one or more selected from the group consisting of ethylene, ethanol, acetate, propanol, and methanol.

Hereinafter, the present disclosure will be described in more detail through examples. These examples are only for exemplifying the present disclosure, and it will be obvious to those of ordinary skill in the art that the scope of the present disclosure should not be construed as being limited by these examples.

### Example 1. Carbon Dioxide Capture and Conversion

### (1) Preparation of Catalyst Ink

A catalyst ink was prepared by applying sonication. Catalyst ink 1 (layer 1) was prepared by dissolving 60 mg of Ag and 5 wt % Nafion in 5 mL of isopropanol. Furthermore, catalyst ink 2 (layer 2) was prepared by dissolving Ketjen 600 carbon and a polymer electrolyte poly(diallyl dimethylammonium) chloride (PDDA) in a ratio of 1:2 in isopropanol.

### (2) Preparation of Reduction Electrode

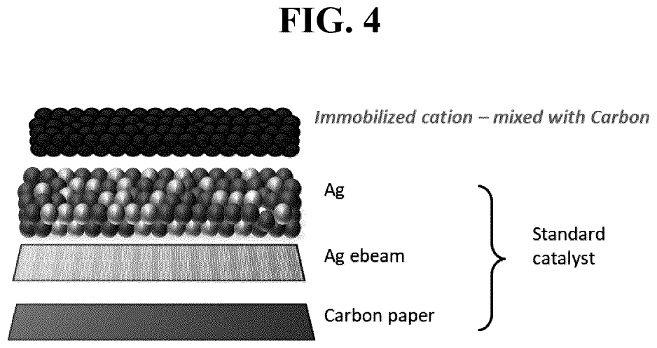

The prepared catalyst ink was sprayed onto the surface of a carbon paper electrode having an area of 1 cm² using a spray gun. The spraying procedure was as follows: catalyst ink 1 was sprayed (loading amount 1.5 mg/cm), and then catalyst ink 2 (loading amount 0.5 mg/cm) was sprayed. Further, spraying was performed uniformly using a hot plate set at 70° C. and a vacuum pump. FIG. 4 illustrates a schematic view of a reduction electrode.

### (3) Preparation of Electrochemical Reactor

The prepared Ag electrode was used as a reduction electrode, and a nickel foam (length 200 mm, width 300 mm, thickness 1.6 mm, MTI Korea) was used as an oxidation electrode. As an electrochemical reactor, a ‘zero gap membrane-electrode assembly’ (Complete 5 cm² CO₂ Electrolyzer manufactured by Dioxide Materials) was used. The reactor has flow paths capable of supplying fluids to a reduction reaction unit and an oxidation reaction unit, and electricity may be applied to each of the reaction units. A bipolar separation membrane (Fumasep FBM) was disposed between an anode and a cathode, and the electrode size was set at 5 cm². As carbon dioxide capture agents, a 25% aqueous solution of tetramethylammonium hydroxide, a 35% aqueous solution of tetraethylammonium hydroxide, and a 35% aqueous solution of tetrabutylammonium hydroxide were used, and the carbon dioxide capture agent solutions were saturated with CO₂ for 1 hour to 2 hours before performing the electrochemical reaction. The carbon dioxide capture agent solution was used as a reduction electrode electrolyte, and 1 M KOH (Sigma-Aldrich, >90%) was used as an oxidation electrode electrolyte.

### (4) Performing Electrochemical Reactions

A potentiostat apparatus (potentiostat VSP with booster 20A, BioLogic Science Instruments) was used to apply electrical energy to an electrochemical reactor, thereby converting the captured CO₂. The gaseous products generated by the conversion of CO₂ through the application of voltage were collected through a first outlet line through which a syngas is discharged and analyzed by gas chromatography (GC), and the concentrations of formate, bicarbonate, and OH in the CO₂ capture solution of the CO₂ capture unit were analyzed by ¹³C NMR by collecting a 1 ml sample. The faradaic efficiency values of the gas and liquid products were calculated according to the following equations:

$$faradaic efficiency = \frac{{i}_{p}}{{i}_{t o t a l}} \times 100 \% = \frac{{V}_{p} \times Q \times \frac{{z}_{p \times P \times F}}{R \times T}}{{i}_{total}} \times 100 \%$$

$${I}_{p} = partial current of product \\ {I}_{total} = total current \\ {V}_{p} = volume concentration of product$$

$$Q = flow rate \\ P = atmosphere pressure ( 101.325 kPa ) \\ R = ideal gas constant \\ T = temperature$$

### Experimental Result 1

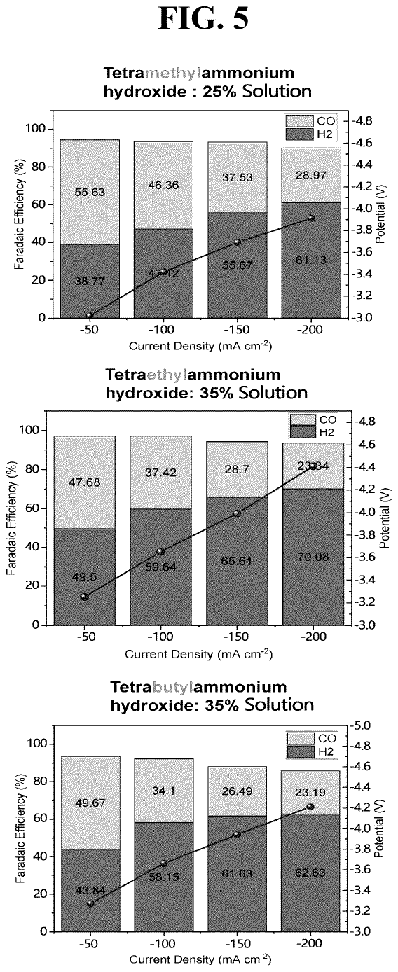

FIG. 5 shows the results obtained by applying constant currents (−20, −50, −100, −150, and −200 mA/cm²) for an hour. The corresponding cell voltages were represented as dots. As a result of comparing the carbon monoxide production efficiencies according to the type of carbon dioxide capture agent, it was confirmed that tetramethylammonium hydroxide, tetraethylammonium hydroxide, and tetrabutylammonium hydroxide all showed excellent conversion performance, and that tetramethylammonium hydroxide provided the best carbon monoxide production efficiency.

### Experimental Result 2

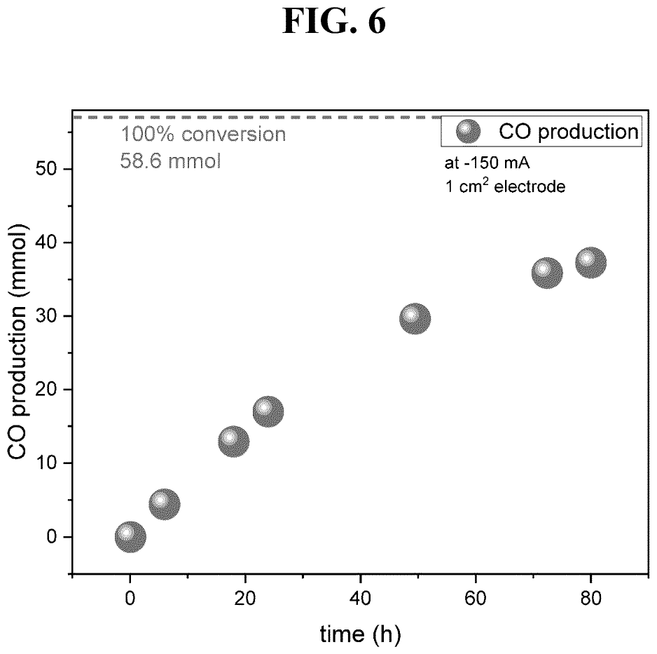

FIGS. 6 to 8 illustrate the results of a long-term reaction of 80 hours using tetraethylammonium hydroxide as a carbon dioxide capture agent. A constant current of 150 mA/cm² was applied, the amount of CO produced in this case was analyzed by GC, and a carbon dioxide capture solution was collected at 24 hours, 49.5 hours, 72.6 hours, and 80 hours to analyze the concentrations of formate, bicarbonate, and OH present in the solution by ¹³C NMR.

As a result, it was confirmed that when a 35% aqueous solution of tetraethylammonium hydroxide containing captured carbon dioxide was subjected to an electrochemical reaction for a long period of time, the bicarbonate reacted to release carbon dioxide, thereby regenerating the carbon dioxide capture agent to the initial state.

Specifically, it was confirmed that about 64% of the captured carbon dioxide was converted into carbon monoxide during a long-term reaction of 80 hours (see the following Table 1 and FIG. 6).

TABLE 1

| | | CO₂ conversion to |
|---|---|---|
| Time (h) | CO (mol) | CO (%) |
| 0 | 0 | 0 |
| 6 | 0.00441 | 7.608 |
| 18 | 0.0129 | 22.237 |
| 24 | 0.0169 | 29.249 |
| 49.5 | 0.0296 | 51.095 |
| 72.4 | 0.0359 | 61.824 |
| 80 | 0.03727 | 64.258 |

(initial volume: 25 mL, Mol_{CO2} = 0.0586 (Mw = 147.26))

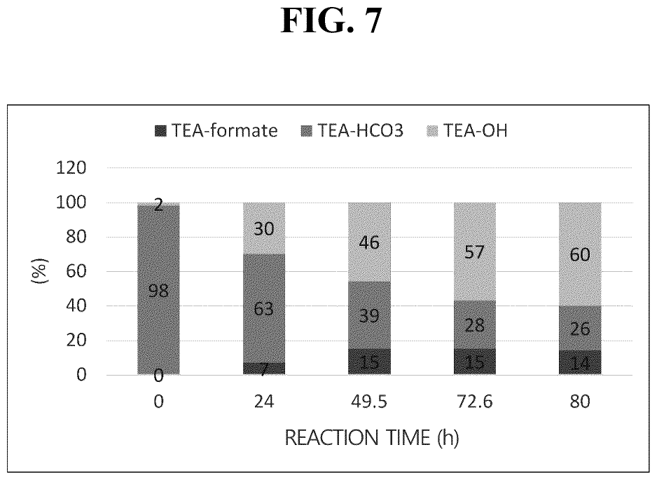

In addition, it was confirmed that as the reaction proceeds, the concentration of bicarbonate (TEA-HCO₃) in the form in which CO₂ is captured, decreases while the concentration of OH (TEA-OH) increases. This indicates that the bicarbonate was converted into CO via the CO₂ conversion reaction, and through this reaction, TEA-OH was regenerated, thereby returning the capture agent to its initial tetraethylammonium hydroxide (see FIG. 7). The analytical methods for each chemical species are as shown in the following Table 2.

TABLE 2

| Chemical species | |
|---|---|
| (%) | Analytical method |
| TEA-formate (%) | TEA-formate moles/initial TEA-OH moles * 100 |
| TEA-HCO₃ (%) | TEA-HCO₃ moles/initial TEA-OH moles * 100 |
| TEA-OH (%) | 100 − (TEA-formate + TEA-HCO₃) |
| Initial TEA-OH | 59.4 mmol |
| (mmol) | |

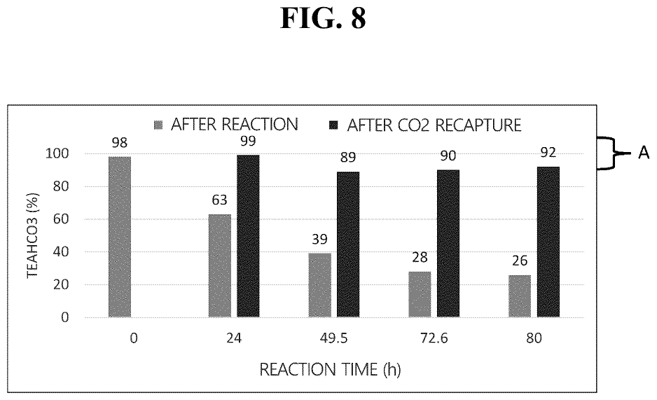

FIG. 8 shows the results of confirming the recapture performance of the carbon dioxide capture agent regenerated after the electrochemical reaction. In FIG. 8, part A is considered to represent the portion lost due to the formation of TEA-formate. When the concentration of TEA-HCO₃, in which the carbon dioxide capture agent and bicarbonate form an ionic bond, was measured, it was confirmed that bicarbonate (HCO₃⁻) was depleted as a result of the electrochemical reaction. Furthermore, it was confirmed that when the amount of bicarbonate decreased and carbon dioxide was recaptured in TEA-OH, the initial capture capacity was effectively restored. Therefore, when carbon dioxide was recaptured in the carbon dioxide capture solution that had undergone an electrochemical reaction, efficient carbon dioxide capture was observed proportional to the amount of regenerated TEA-OH.

Although the specific part of the present disclosure has been described in detail, it will be apparent to those of ordinary skill in the art that such a specific description is just a preferred embodiment and the scope of the present disclosure is not limited thereby. Therefore, the substantial scope of the present disclosure will be defined by the appended claims and equivalents thereof.

What is claimed is:

1. A carbon dioxide capture agent having a structure of the following Chemical Formula 1: 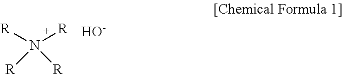
wherein in the formula, R is an alkyl having 1 to 6 carbon atoms.

2. The carbon dioxide capture agent of claim 1, wherein the capture agent has any one of the structures of Chemical Formulae 2 to 5:

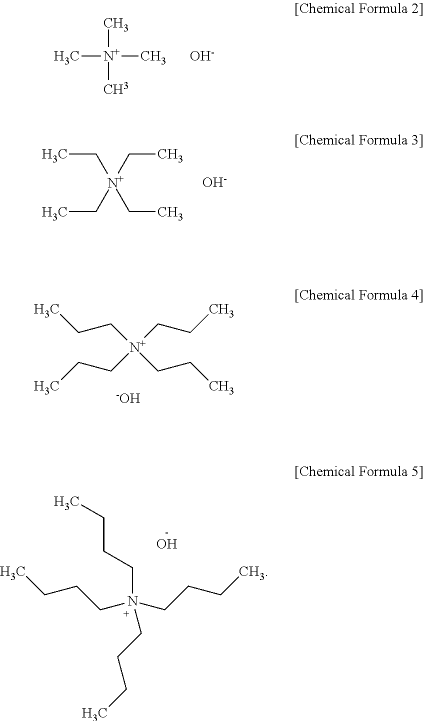

3. The carbon dioxide capture agent of claim 1, wherein the carbon dioxide capture agent is used at a concentration of 20 wt % or more based on a total weight of a capture agent solution.

4. The carbon dioxide capture agent of claim 1, wherein the capture agent is capable of capturing carbon dioxide at a concentration of 10 ppm to 5,000 ppm.

5. The carbon dioxide capture agent of claim 1, wherein the capture agent is reusable after an electrochemical reaction of the captured carbon dioxide.

6. A carbon dioxide capture and reduction system using the carbon dioxide capture agent according to claim 1, the system comprising:
an electrochemical reaction unit comprising a reduction electrode, an oxidation electrode, and a separation membrane separating the reduction electrode and the oxidation electrode;
a carbon dioxide capture unit supplying a carbon dioxide capture solution to the reduction electrode of the electrochemical reaction unit; and
an oxidation reaction electrolyte unit supplying an aqueous solution to the oxidation electrode of the electrochemical reaction unit,
wherein the carbon dioxide capture unit comprises the carbon dioxide capture agent.

7. The carbon dioxide capture and reduction system of claim 6, wherein the carbon dioxide capture unit comprises:
a first supply line through which the carbon dioxide capture solution is supplied to the reduction electrode of the electrochemical reaction unit;
a first inlet line through which a reduction electrode reactant is introduced; and
a first outlet line through which a syngas in the reduction electrode reactant is discharged.

8. The carbon dioxide capture and reduction system of claim 6, wherein the system supplies the carbon dioxide capture solution to the reduction electrode of the electrochemical reaction unit, reduces captured carbon dioxide through an electrochemical reaction, and introduces a reduction reactant into the carbon dioxide capture unit.

9. The carbon dioxide capture and reduction system of claim 8, wherein the system further comprises capturing carbon dioxide in the carbon dioxide capture unit.

10. The carbon dioxide capture and reduction system of claim 8, wherein the system further comprises reusing a carbon dioxide capture agent contained in the reduction reactant introduced into the carbon dioxide capture unit, to supply a carbon dioxide capture solution comprising captured carbon dioxide to the reduction electrode of the electrochemical reaction unit.

11. The carbon dioxide capture and reduction system of claim 8, wherein the reduction reactant comprises a compound produced through the electrochemical reaction and a carbon dioxide capture agent in an initial capture agent state.

12. The carbon dioxide capture and reduction system of claim 8, wherein the reduction electrode comprises one or more metals selected from the group consisting of silver, gold, zinc, nickel, cobalt, iron, and manganese, and the reduction reactant comprises carbon monoxide.

13. The carbon dioxide capture and reduction system of claim 8, wherein the reduction electrode comprises one or more metals selected from the group consisting of tin, copper, bismuth, palladium, and indium, and the reduction reactant comprises formate.

14. The carbon dioxide capture and reduction system of claim 8, wherein the reduction electrode comprises copper metal, and the reduction reactant comprises one or more selected from the group consisting of ethylene, ethanol, acetate, propanol, and methanol.
